(19) United States
(12) Patent Application Publication
(10) Pub. No.: US 2026/0126337 A1
(43) Pub. Date: May 7, 2026

(54) SYSTEM AND METHOD FOR SIMULTANEOUSLY CONTROLLING OPERATIONS OF A PLURALITY OF TESTING DEVICES

(71) Applicant: Aeroseal LLC, Miamisburg, OH (US)

(72) Inventors: Mark Modera, Piedmont, CA (US); Santosh Deevi, Centerville, OH (US); Kyle McClary, Beavercreek, OH (US); Michael Joesph Coyle, Tipp City, OH (US); Joel Wesley Summerfield, Dayton, OH (US)

(21) Appl. No.: 18/937,819

(22) Filed: Nov. 5, 2024

(51) Int. Cl. G01M 3/26

(52) U.S. Cl. CPC G01M 3/26

(57) ABSTRACT

A system and a method for controlling operations of a plurality of testing devices are provided. The system receives test data associated with each of a first enclosure and a second enclosure from one or more data sources and receives pressure data from one or more sensors associated with each of the first enclosure and the second enclosure. The first enclosure is associated with a first testing device of the plurality of testing devices and the second enclosure is associated with a second testing device of the plurality of testing devices. The system further generates control data for controlling an operation of each of the first testing device and the second testing device based on the test data and the pressure data and outputs the control data for controlling the operation of each of the first testing device and the second testing device.

### TECHNICAL FIELD

The present disclosure generally relates to control systems and more particularly relates to a system and method for simultaneously controlling operations of a plurality of testing devices.

### BACKGROUND

Air leakage sealing process is a critical process for maintaining the energy efficiency and structural integrity of the building's envelope. The air leakage sealing process refers to the process of identifying and sealing gaps, seams, and openings in ducts associated with HVAC (Heat Ventilation and Air Conditioning) systems and building envelopes to prevent the unintended escape of conditioned air. The air leakage sealing is primarily used in residential and commercial buildings, particularly in areas where the ducts are located in unconditioned spaces like attics, basements, or crawl spaces. By sealing air leaks, the HVAC systems operate more efficiently, improve indoor air quality, and enhance overall comfort by maintaining consistent temperatures throughout the space. Additionally, it contributes to environmental sustainability by reducing energy consumption and associated carbon emissions.

The air leakage sealing process typically involves a series of steps from verifying air leaks within the ducts or envelope using an air leakage test to sealing the air leaks using various sealing materials. The air leakage test involves creating a controlled pressure difference between an interior and an exterior of a building. Generally, a testing device, such as a blower or a fan is used to achieve this pressure difference. In this manner, it allows for the precise measurement of air leakage rates. Various sealing materials, such as caulk or weatherstripping may then be used to properly seal the air leaks. In certain cases, large gaps may be sealed using foam insulation.

The accuracy and reliability of the air leakage test is highly dependent on the ability to control an operation of the testing device with precision. The precise control of the testing device is also required during the air leakage sealing process of identified air leakages in the ducts or envelope. To this end, the ducts or envelopes also have a predefined maximum safe pressure of operation of the testing device that needs to be observed to avoid physical damage.

However, for performing the air leakage sealing process at multiple building envelopes, multiple testing devices need to be used. These multiple testing devices may be controlled by using, for example, manual adjustments or multiple rudimentary automated systems. Using multiple automated systems for controlling the multiple testing devices may increase the overall costs associated with the sealing process. Also, using a single testing device to perform the sealing process at each building envelope may be time-consuming. Moreover, these manual adjustments and these multiple rudimentary automated systems may not provide the necessary level of precision and adaptability for different testing conditions and/or maintain pressure within the predefined maximum safe pressure.

Therefore, there is a need for a centralized system to precisely control operations of the multiple testing devices to achieve desired and safe operating pressure within multiple building envelopes for precisely performing the air leakage sealing process while preventing any physical damages.

### BRIEF SUMMARY

A system, a method, and a computer programmable product are provided for controlling operations of a plurality of testing devices.

In one aspect, a system for controlling operations of a plurality of testing devices is provided. The system includes a memory configured to store computer executable instructions and one or more processors configured to execute the instructions to receive test data associated with each of a first enclosure and a second enclosure from one or more data sources. The first enclosure is associated with a first testing device of the plurality of testing devices and the second enclosure is associated with a second testing device of the plurality of testing devices. The one or more processors are further configured to receive pressure data from one or more sensors associated with each of the first enclosure and the second enclosure. The pressure data includes a first pressure value associated with the first enclosure with the first testing device operating therein and a second pressure value associated with the second enclosure with the second testing device operating therein. The one or more processors are further configured to generate control data for controlling an operation of each of the first testing device and the second testing device based on the test data and the pressure data. The control data includes a first control signal for controlling the operation of the first testing device and a second control signal for controlling the operation of the second testing device. The operation of each of the first testing device and the second testing device is controlled to achieve a predefined pressure condition within each of the first enclosure and the second enclosure. The one or more processors are further configured to output the control data via a user interface for controlling the operation of each of the first testing device and the second testing device.

In an embodiment, the predefined pressure condition is associated with performing one of a sealing operation within each of the first enclosure and the second enclosure or a testing operation within each of the first enclosure and the second enclosure.

In an embodiment, the one or more processors are further configured to generate the first control signal for controlling the operation of the first testing device based on the test data and the pressure data associated with the first enclosure. The one or more processors are further configured to generate the second control signal for controlling the operation of the second testing device based on the test data and the pressure data associated with the second enclosure and cause to control the operation of the first testing device and the second testing device simultaneously based on the first control signal and the second control signal.

In an embodiment, the one or more processors are further configured to transmit the first control signal to a first control unit associated with the first testing device. The one or more processors are further configured to transmit the second control signal to a second control unit associated with the second testing device and cause each of the first control unit and the second control unit to control the first testing device and the second testing device to achieve the predefined pressure condition within each of the first enclosure and the second enclosure.

In an embodiment, the one or more processors are further configured to receive feedback data associated with at least one of the first enclosure, the second enclosure, the first testing device or the second testing device based on an operation of each of the first testing device within the first enclosure and the second testing device within the second enclosure. The one or more processors are further configured to generate updated control data for controlling an operation of at least one of the first testing device or the second testing device based on the feedback data and the predefined pressure condition. The updated control data includes at least one of an updated first control signal for the first testing device, or an updated second control signal for the second testing device. The one or more processors are further configured to transmit the updated control data to at least one of the first control unit or the second control unit and cause at least one of the first control unit or the second control unit to control corresponding the first testing device or the second testing device based on the updated control data.

In an embodiment, the one or more processors are further configured to cause the first control unit to control the first testing device based on the updated first control signal and simultaneously cause the second control unit to control the second testing device based on the updated second control signal or vice-versa.

In an embodiment, the feedback data includes at least one of updated first pressure value associated with the first enclosure, updated second pressure value associated with the second enclosure, first operation parameters associated with the operation of the first testing device, or second operation parameters associated with the operation of the second testing device.

In an embodiment, the one or more processors are further configured to compare the updated first pressure value associated with the first enclosure with a predefined threshold value associated with the predefined pressure condition. The one or more processors are further configured to generate the updated first control signal based on the comparison and the first operation parameters associated with the operation of the first testing device.

In an embodiment, the one or more processors are further configured to compare the updated second pressure value associated with the second enclosure with a predefined threshold value associated with the predefined pressure condition. The one or more processors are further configured to generate the updated second control signal based on the comparison and the second operation parameters associated with the operation of the second testing device.

In an embodiment, the one or more processors are further configured to receive, via the user interface, a user input associated with the operation of at least one of the first testing device or the second testing device and generate the updated control data for controlling the operation of at least one of the first testing device and the second testing device based on the user input.

In an embodiment, the test data includes at least one of pressure characteristics data associated with each of the first enclosure and the second enclosure, flow characteristics data associated with each of the first enclosure and the second enclosure, and leakage characteristics data associated with each of the first enclosure and the second enclosure.

In an embodiment, each of the one or more sensors is a manometer.

In an embodiment, each of the first testing device and the second testing device is one of a fan, a compressor or a pump.

In an embodiment, each of the first testing device and the second testing device supplies a fluid to each of the first enclosure and the second enclosure. The fluid includes at least a portion of an aerosolized sealant.

In an embodiment, the first testing device is associated with a first sealant delivery unit and the second testing device is associated with a second sealant delivery unit. Each of the first sealant delivery unit and the second sealant delivery unit disperses a stream of the aerosolized sealant into the respective first enclosure and the second enclosure.

In another aspect, a method for controlling operations of a plurality of testing devices is provided. The method includes receiving test data associated with each of a first enclosure and a second enclosure from one or more data sources. The first enclosure is associated with a first testing device of the plurality of testing devices and the second enclosure is associated with a second testing device of the plurality of testing devices. The method further includes receiving pressure data from one or more sensors associated with each of the first enclosure and the second enclosure. The pressure data includes a first pressure value associated with the first enclosure with the first testing device operating therein and a second pressure value associated with the second enclosure with the second testing device operating therein. The method further includes generating control data for controlling an operation of each of the first testing device and the second testing device based on the test data and the pressure data. The control data includes a first control signal for controlling the operation of the first testing device and a second control signal for controlling the operation of the second testing device. The operation of each of the first testing device and the second testing device is controlled to achieve a predefined pressure condition within each of the first enclosure and the second enclosure. The method further includes outputting the control data via a user interface for controlling the operation of each of the first testing device and the second testing device.

In an embodiment, the method further includes generating the first control signal for controlling the operation of the first testing device based on the test data and the pressure data associated with the first enclosure. The method further includes transmitting the first control signal to a first control unit associated with the first testing device. The method further includes generating the second control signal for controlling the operation of the second testing device based on the test data and the pressure data associated with the second enclosure. The method further includes transmitting the second control signal to a second control unit associated with the second testing device. The method further includes causing each of the first control unit and the second control unit to control the first testing device and the second testing device to achieve the predefined pressure condition within each of the first enclosure and the second enclosure.

In an embodiment, the method further includes receiving feedback data associated with at least one of the first enclosure, the second enclosure, the first testing device or the second testing device based on an operation of each of the first testing device within the first enclosure and the second testing device within the second enclosure. The method further includes generating updated control data for controlling an operation of at least one of the first testing device or the second testing device based on the feedback data and the predefined pressure condition. The updated control data includes at least one of an updated first control signal for the first testing device, or an updated second control signal for the second testing device. The method further includes transmitting the updated control data to at least one of the first control unit or the second control unit and causing at least one of the first control unit or the second control unit to control corresponding the first testing device or the second testing device based on the updated control data.

In yet another aspect, a computer programmable product for controlling operations of a plurality of testing devices is provided. The computer programmable product includes a non-transitory computer readable medium having stored thereon computer executable instructions, which when executed by one or more processors, cause the one or more processors to conduct operations. The operations include receiving test data associated with each of a first enclosure and a second enclosure from one or more data sources. The first enclosure is associated with a first testing device of the plurality of testing devices and the second enclosure is associated with a second testing device of the plurality of testing devices. The operations further include receiving pressure data from one or more sensors associated with each of the first enclosure and the second enclosure. The pressure data includes a first pressure value associated with the first enclosure with the first testing device operating therein and a second pressure value associated with the second enclosure with the second testing device operating therein. The operations further include generating control data for controlling an operation of each of the first testing device and the second testing device based on the test data and the pressure data. The control data includes a first control signal for controlling the operation of the first testing device and a second control signal for controlling the operation of the second testing device. The operation of each of the first testing device and the second testing device is controlled to achieve a predefined pressure condition within each of the first enclosure and the second enclosure. The operations further include outputting the control data via a user interface for controlling the operation of each of the first testing device and the second testing device.

In an embodiment, the operations further include receiving feedback data associated with at least one of the first enclosure, the second enclosure, the first testing device or the second testing device based on an operation of each of the first testing device within the first enclosure and the second testing device within the second enclosure. The operations further include generating updated control data for controlling an operation of at least one of the first testing device or the second testing device based on the feedback data and the predefined pressure condition. The updated control data includes at least one of an updated first control signal for the first testing device, or an updated second control signal for the second testing device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the disclosure in general terms, reference will now be made to the accompanying drawings, which are not necessarily drawn to scale, and wherein:

FIG. 1A illustrates a block diagram of a network environment including a system for controlling operations of a plurality of testing devices, in accordance with one or more embodiments of the present disclosure;

FIG. 1B illustrates a block diagram of an exemplary network environment including the system of FIG. 1A, in accordance with an example embodiment of the present disclosure;

FIG. 2 illustrates an exemplary block diagram of the system of FIG. 1A, in accordance with an example embodiment of the present disclosure;

FIG. 3 illustrates an exemplary block diagram of a test environment including a sealant delivery unit and a fluid delivery unit, in accordance with an example embodiment of the present disclosure;

FIG. 4 is a diagram that illustrates a first set of exemplary operations for controlling operations of a plurality of testing devices, in accordance with an example embodiment of the present disclosure;

FIG. 5 is a diagram that illustrates a second set of exemplary operations for controlling operations of a plurality of testing devices, in accordance with an example embodiment of the present disclosure;

FIG. 6 is a diagram that illustrates a first exemplary method for generating updated control data, in accordance with an example embodiment of the present disclosure;

FIG. 7 is a diagram that illustrates a second exemplary method for generating updated control data, in accordance with an example embodiment of the present disclosure; and

FIG. 8 is a flowchart that illustrates an exemplary method for controlling operations of a plurality of testing devices, in accordance with an example embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatus and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

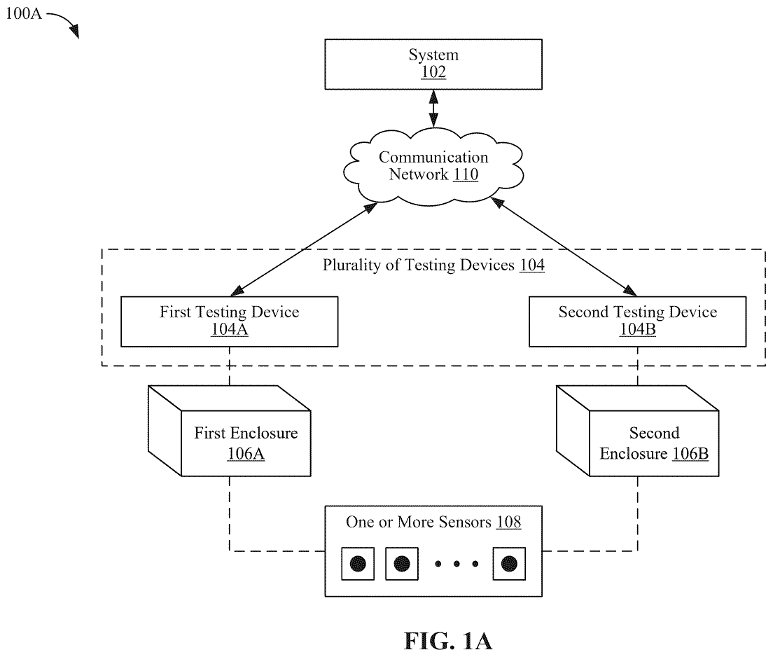

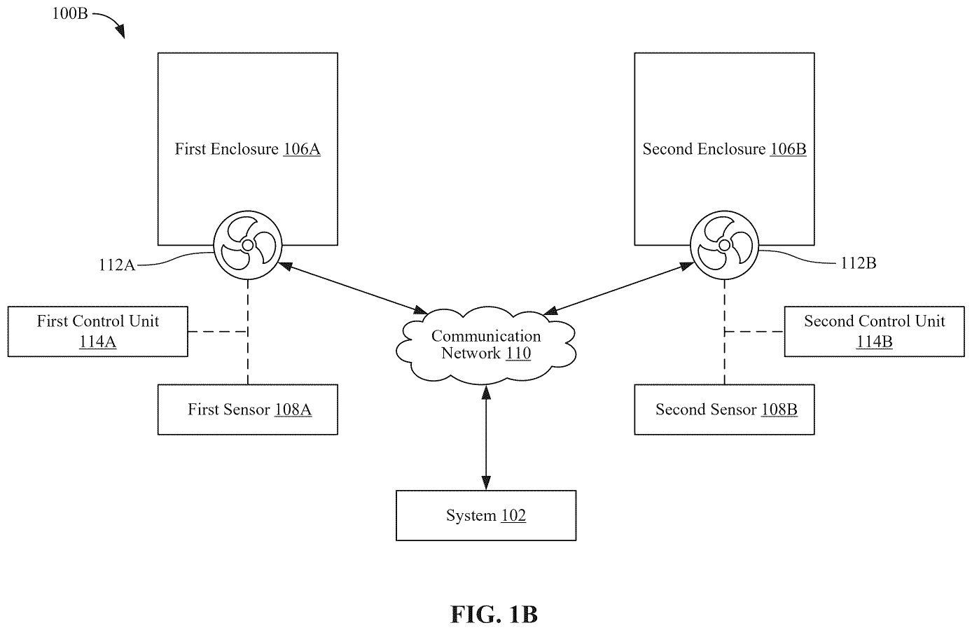

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 8, a brief description concerning the various components of the present disclosure will now be briefly discussed. Reference will be made to the figures showing various embodiments of a system for providing a user with an interactive map.

Conventionally, the control of operations of multiple testing devices for simultaneously performing a sealing process at multiple building enclosures used to heavily rely on manual adjustments or multiple rudimentary automated systems. These manual adjustments were labor-intensive cumbersome, time consuming and required significant expertise, that may be used to reduce the overall efficiency of the sealing process. Moreover, the manual adjustments and these rudimentary automated systems may not provide the necessary level of accuracy and precision in performing the sealing process.

Additionally, these manual adjustments and the rudimentary automated systems may not provide adaptability for different testing conditions. The manual adjustments and the rudimentary automated systems were not being able to maintain pressure within a maximum safe pressure inside the building enclosures which may result in causing physical damage to the building. Moreover, using multiple automated systems for controlling operations of the multiple testing devices may increase the overall costs associated with the sealing process. Also, using a single testing device to perform the sealing process at each building enclosure may be a time-consuming task.

Various embodiments are provided herein for controlling operations of a plurality of testing devices. The embodiments described in the present disclosure may enable a centralized control of the operations of the plurality of testing devices for simultaneously controlling each of the plurality of testing devices. The centralized control of the operations of the plurality of testing devices eliminates the need of using the multiple rudimentary automated systems which solves the problem of increased costs associated with the sealing process.

Furthermore, the centralized control of the operations of the plurality of testing devices may provide an accurate and a precise control over the operations of the plurality of testing devices. The centralized control of the operations of the plurality of testing devices may further be adaptable to different kinds of testing environment and may help in maintaining the pressure within the maximum safe pressure within each building enclosure to prevent any kinds of physical damages to the building.

Embodiments of the present disclosure may provide a system, a method and a computer programmable product for controlling operations of a plurality of testing devices. The present disclosure may provide a cost-effective solution for simultaneously controlling the operations of the plurality of testing devices. The present disclosure may further ensure accurate measurement of the air leakage rates in multiple HVAC systems and the multiple building enclosures for precisely performing the sealing process. The present disclosure mitigates the limitations associated with the traditional methods.

FIG. 1A illustrates a block diagram of a network environment 100A including a system for controlling operations of a plurality of testing devices, in accordance with one or more embodiments of the present disclosure. With reference to FIG. 1A, there is shown the block diagram of the network environment 100A. The network environment 100A includes a system 102 and a plurality of testing devices 104. The network environment 100A further includes a first enclosure 106A, a second enclosure 106B, one or more sensors 108 and a communication network 110. The plurality of testing devices 104 includes a first testing device 104A and a second testing device 104B.

The system 102 includes suitable logic, circuitry, interfaces, and/or code that may be configured to control operations of the plurality of testing devices 104. Specifically, the system 102 is configured to output control data for controlling the operations of each of the first testing device 104A and the second testing device 104B. Examples of the system 102 may include, but are not limited to, an electronic control unit (ECU), an electronic control module (ECM), a computing device, a mainframe machine, a server, a computer workstation, any and/or any other device.

In another example embodiment, the system 102 may be embodied as a cloud-based service, a cloud-based application, a cloud-based platform, a remote server-based service, a remote server-based application, a remote server-based platform, or a virtual computing system. In yet another example embodiment, the system 102 may be an OEM (Original Equipment Manufacturer) cloud.

The sealing process refers to a method of identifying and sealing gaps, seams, and openings in ducts associated with HVAC (Heat Ventilation and Air Conditioning) systems and building envelopes to prevent the unintended escape of conditioned air. The purpose of the sealing process is to identify and seal air leaks present in the HVAC systems and the building envelopes, which help them operate more efficiently, improve indoor air quality, and enhance overall comfort by maintaining consistent temperatures throughout the space. Additionally, the sealing process also contributes to environmental sustainability by reducing energy consumption and associated carbon emissions. The sealing process is performed in a series of steps.

Firstly, an air leakage test is performed. The air leakage test refers to a method to verify the presence of one or more leaks in an enclosure, such as a building, a room, etc. The air leakage test, also known as a blower door test, is a diagnostic procedure used to measure a rate at which air infiltrates or exfiltrates through the enclosure, such as a building's envelope. At the end, a sealant is directed into the enclosure for sealing the one or more identified leaks.

For accurately performing the air leakage test, each of the first enclosure 106A and the second enclosure 106B must be pressurized to maintain a predefined pressure condition for detecting the one or more leaks accurately. The rotation of each of the first testing device 104A and the second testing device 104B provides airflow which is required for pressurizing the first enclosure 106A and the second enclosure 106B. Improper control of either of the first testing device 104A or the second testing device 104B may result in inaccurate detection of the one or more leaks.

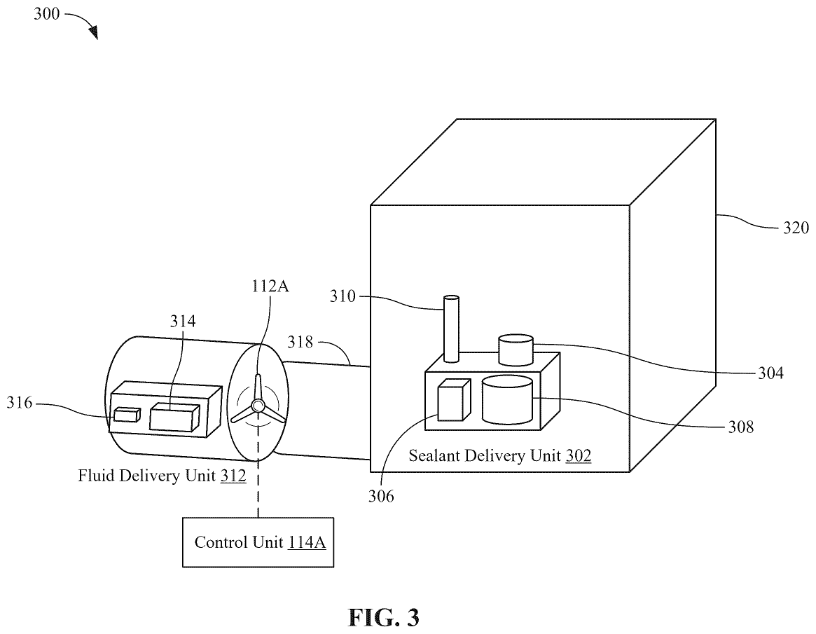

Furthermore, the sealing process requires each of the first enclosure 106A and the second enclosure 106B to be pressurized to the predefined pressure condition to direct the sealant for sealing the one or more leaks. Similarly, the precise control of each of the first testing device 104A and the second testing device 104B is required to maintain the predefined pressure condition for the sealing process. In this regard, a sealant delivery unit is further utilized for injecting adhesive particles (the sealant) for sealing the one or more leaks identified during the air leakage test. The adhesive particles or the sealant travel through the first enclosure 106A and the second enclosure 106B, seeking the presence of the one or more leaks. The adhesive particles further get attached to edges of the one or more leaks, effectively sealing them. Therefore, the precise control of each of the first testing device and second testing device is needed for accurately performing the sealing process. Details about the sealant delivery unit are provided in FIG. 3.

In an embodiment, the predefined pressure condition is associated with performing a sealing operation within each of the first enclosure 106A and the second enclosure 106B, or a testing operation within each of the first enclosure 106A and the second enclosure 106B. The predefined pressure condition corresponds to a predefined target pressure which needs to be maintained within each of the first enclosure 106A and the second enclosure 106B for accurately performing the sealing process and the air leakage test. The sealing operation corresponds to the sealing process within each of the first enclosure 106A and the second enclosure 106B. The testing operation corresponds to the air leakage test within each of the first enclosure 106A and the second enclosure 106B.

The plurality of testing devices 104 includes the first testing device 104A and the second testing device 104B. Each of the first testing device 104A and the second testing device 104B is a rotation device operable to supply a fluid into the first enclosure 106A and the second enclosure 106B, respectively. In an embodiment, each of the first testing device 104A and the second testing device 104B corresponds to for example, but not limited to, a fan, a compressor, or a pump. In an example, the fan or the pump corresponding to each of the first testing device 104A and the second testing device 104B is configured to pressurize the first enclosure 106A and the second enclosure 106B, respectively, to maintain the predefined pressure condition.

In another embodiment, each of the first testing device 104A and the second testing device 104B may be configured to supply the fluid for performing the sealing process within each of the first enclosure 106A and the second enclosure 106B, respectively. The fluid may include at least a portion of an aerosolized sealant. The aerosolized sealant may refer to, but not limited to, a water-based copolymer, which may be capable of sealing one or more leaks identified during the sealing process. In an example, the first testing device 104A and the second testing device 104B may pressurize the first enclosure 106A and the second enclosure 106B, respectively, to maintain the predefined pressure condition, which may allow the aerosolized sealant to force through the one or more leaks for performing the sealing process.

Each of the first enclosure 106A and the second enclosure 106B (collectively referred to as enclosures 160) corresponds to an envelope associated with an HVAC (Heating, Ventilation, and Air Conditioning) system. The enclosures 160 may also include ducts of the HVAC system. Each of the first enclosure 106A and the second enclosure 106B may be provided with conditioned air for heating or cooling. Each of the first enclosure 106A and the second enclosure 106B may be, for example, a room, a living space, a commercial space, an office, a shop, or a duct made of a sheet metal or flex, etc.

Each of the first enclosure 106A and the second enclosure 106B are operable up to maximum safe pressure value which can be maintained without causing any physical damage to the first enclosure 106A and the second enclosure 106B. For example, the sheet metal ducts may have a predefined threshold value of the pressure up to which can be maintained within them, without causing any physical damage. Therefore, to avoid any physical damages to the first enclosure 106A and the second enclosure 106B, the precise control of each of the first testing device 104A and the second testing device 104B, respectively, is needed for maintaining the pressure below the predefined threshold value.

Each of the first enclosure 106A and the second enclosure 106B may be used for distributing conditioned air (heated or cooled) throughout buildings, ensuring comfortable indoor temperatures. Each of the first enclosure 106A and the second enclosure 106B may further be used to provide ventilation in buildings, removing stale air and introducing fresh air. Each of the first enclosure 106A and the second enclosure 106B may further be used for maintaining indoor air quality and preventing humidity buildup.

Each of the one or more sensors 108 includes suitable logic, circuitry, interfaces, and/or code that may be configured to detect and measure physical phenomena, converting them into digital or analog signals that can be processed by the system 102. In an embodiment, the one or more sensors 108 may be configured to determine at least real-time pressure within each of the first enclosure 106A and the second enclosure 106B, and flow rate of air within each of the first enclosure 106A and the second enclosure 106B, respectively, for performing the sealing process. In an example, the one or more sensors 108 may include at least, but not limited to, a pressure sensor and a flow sensor.

In another embodiment, each of the one or more sensors 108 is a manometer. The manometer is a pressure measuring device, which may be configured to determine the real-time pressure. In an example, each of the first testing device 104A and the second testing device 104B includes the one or more sensors 108A for measuring the pressure within the first enclosure 106A and the second enclosure 106B during the sealing process.

The communication network 110 may be wired, wireless, or any combination of wired and wireless communication networks, such as cellular, Wi-Fi, internet, local area networks, or the like. In some embodiments, the communication network 104 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In operation, the system 102 is configured to receive test data associated with each of the first enclosure 106A and the second enclosure 106B from one or more data sources. The first enclosure 106A is associated with the first testing device 104A. Moreover, the second enclosure 106B is associated with the second testing device 104B. The test data may include one or more testing parameters associated with performing the sealing process. The system 102 may receive the test data from the one or more sensors 108, or from a user input. In an example, the system 102 may receive the flow rate of air within each of the first enclosure 106A and the second enclosure 106B from the flow sensor associated with each of the first enclosure 106A and the second enclosure 106B.

Thereafter, the system 102 is configured to receive pressure data from the one or more sensors 108 associated with each of the first enclosure 106A and the second enclosure 106B. The pressure data includes a first pressure value associated with the first enclosure 106A with the first testing device 104A operating therein. The pressure data further includes a second pressure value associated with the second enclosure 106B with the second testing device 104B operating therein. In an example, the system 102 may receive the first pressure value and the second pressure value from the manometer associated with the first enclosure 106A and the second enclosure 106B, respectively.

Furthermore, the system 102 is configured to generate control data for controlling an operation of the first testing device 104A and the second testing device 104B based on the test data and the pressure data. The control data includes a first control signal for controlling the operation of the first testing device 104A. The control data may also include a second control signal for controlling the operation of the second testing device 104B. The operation of each of the first testing device 104A and the second testing device 104B is controlled to achieve the predefined pressure condition within each of the first enclosure 106A and the second enclosure 106B.

In an exemplary embodiment, the system 102 determines that each of the first pressure value and the second pressure value is less than the predefined target pressure which needs to be maintained to achieve the predefined pressure conditions. The system 102 may then generate the control data to control the operation of speeding up each of the first testing device 104A or the second testing device 104B.

To this end, the system 102 is configured to output the control data via a user interface for controlling the operation of each of the first testing device 104A and the second testing device 104B. The system 102 may output the control data to a user for controlling the operation of each of the first testing device 104A and the second testing device 104B. In an example, the user corresponds to an operator associated with a building, where the first enclosure 106A and the second enclosure 106B may be installed.

FIG. 1B illustrates a block diagram of an exemplary network environment 100B including a system for controlling operations of a plurality of testing devices, in accordance with an example embodiment of the present disclosure. With reference to FIG. 1B, there is shown the block diagram of the network environment 100B. The network environment 100B includes the system 102, a first testing device 112A and a second testing device 112B. The network environment 100B further includes the first enclosure 106A, the second enclosure 106B and the communication network 110. The first testing device 112A is connected to and/or controlled by a first control unit 114A. Similarly, the second testing device 112B is connected to and/or controlled by a second control unit 114B.

Each of the first testing device 112A and the second testing device 112B is an exemplary embodiment of the first testing device 104A and the second testing device 104B, respectively. In an embodiment, each of the first testing device 112A and the second testing device 112B corresponds to a fan. In an additional embodiment, the fan corresponding to each of the first testing device 112A and the second testing device 112B is configured to pressurize the first enclosure 106A and the second enclosure 106B, respectively, to maintain the predefined pressure condition therein.

In another embodiment, each of the first sensor 108A and the second sensor 108B is a manometer. The manometer is a pressure measuring device, which may be configured to determine the real-time pressure. In an embodiment, each of the first testing device 114A and the second testing device 114B includes the first sensor 108A and the second sensor 108B for measuring the pressure within the first enclosure 106A and the second enclosure 106B, respectively, during the sealing process.

Each of the first control unit 114A and the second control unit 114B includes suitable logic, circuitry, and/or code that may be configured to control the operations of the first testing device 112A and the second testing device 112B, respectively. Specifically, each of the first control unit 114A and the second control unit 114B may be configured to receive a control signal from the system 102 and then control the operation of the first testing device 112A and the second testing device 112B, respectively. Examples of the each of the first control unit 114A and the second control unit 114B may include, one of but not limited to, a programmable logic controller (PLC), a microcontroller, a sensor-based controller, an electronic control unit (ECU), an electronic control module (ECM), a computing device, a server, or/and any other device.

Since, each of the first testing device 112A and the second testing device 112B is an exemplary embodiment of the first testing device 104A and the second testing device 104B, respectively, therefore each of the first testing device 104A and the second testing device 104B may be controlled by the first control unit 114A and the second control unit 114B, respectively. The first control unit 114A may receive the first control signal from the system 102 and control the operation of the first testing device 104A. The second control unit 114B may simultaneously receive the second control signal from the system 102 and control the operation of the second testing device 104B. Each of the first control unit 114A and the second control unit 114B may be connected to the system 102 via the communication network 110.

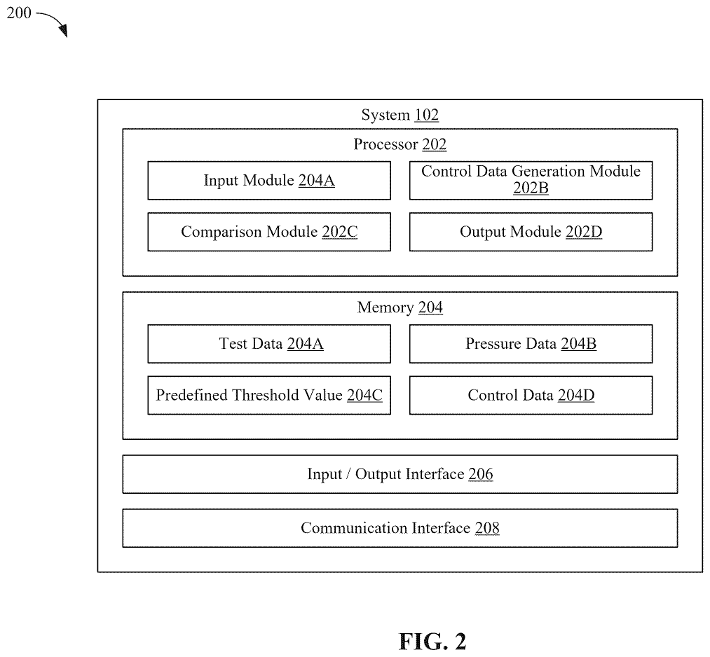

FIG. 2 illustrates a block diagram 200 of the system 102 of FIG. 1, in accordance with an example embodiment of the disclosure. FIG. 2 is explained in conjunction with elements of FIG. 1A and FIG. 1B.

The system 102 may include at least one processor 202 (referred to as a processor 202, hereinafter), at least one non-transitory memory 204 (referred to as a memory 204, hereinafter), an input/output (I/O) interface 206, and a communication interface 208. The processor 202 may include modules, depicted as, an input module 202A, a control data generation module 202B, a comparison module 202C, and an output module 202D.

The processor 202 may be connected to the memory 204, and the I/O interface 206 through wired or wireless connections. Although in FIG. 2, it is shown that the system 102 includes the processor 202, the memory 204, and the I/O interface 206, however, the disclosure may not be so limiting and the system 102 may include fewer or more components to perform the same or other functions of the system 102. In an embodiment, the input module 202A and the output module 202D may be integrated within the I/O interface 206. In some embodiments, the input module 202A may receive data obtained by the system 102 and the output module 202B may output the data generated by the system 102. In an example, the data obtained by the system 102 may include at least sensor data (from the one or more sensors 108) and the data generated by the system 102 may include control data 204D.

In accordance with an embodiment, the system 102 may store data generated by the modules of the processor 202 in the memory 204. The data generated by the modules may include test data 204A, pressure data 204B, a predefined threshold value 204C, and the control data 204D. Each of the test data 204A, the pressure data 204B, the predefined threshold value 204C, and the control data 204D, is further explained in detail.

The processor 202 of the system 102 may be configured to control the operations of the plurality of testing devices 104. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100 may be accessed using the communication interface 208 of the system 102. The communication interface 208 may provide an interface for accessing various features and data stored in the system 102.

In some embodiments, the processor 202 may be configured to provide Internet-of-Things (IoT) related capabilities to users of the system 102 disclosed herein. The IoT-related capabilities may in turn be used for controlling the operation of each of the plurality of testing devices 104. The I/O interface 206 may provide an interface for accessing various features and data stored in the system 102.

The input module 202A may be configured to receive the test data 204A associated with each of the first enclosure 106A and the second enclosure 106B from the one or more data sources. In an example, the input module 202A of the processor 202 receives the test data 204A from the one or more sensors 108. In an alternate example, the input module 202A of the processor 202 may further receive the test data 204B from the user input. In another embodiment, the input module 202B may be further configured to receive the pressure data 204B from the one or more sensors 108.

The control data generation module 202B may be configured to generate the control data 204D. The control data generation module 202B may generate the control data 204D based on the test data 204A and the pressure data 204B received from the input module 202A. The control data 204D may include the first control signal for controlling the operation of the first testing device 104A and the second control signal for controlling the operation of the second testing device.

The comparison module 202C may be configured to compare the test data 204A and the pressure data 204B with the predefined pressure condition. The pressure data 204B includes the first pressure value and the second pressure value associated with the pressure within each of the first enclosure 106A and the second enclosure 106B and the predefined pressure condition may correspond to the predefined target pressure which needs to be maintained within each of the first enclosure 106A and the second enclosure 106B for performing the sealing process. Specifically, the comparison module 202C may compare the first pressure value and the second pressure value, respectively, with the predefined target pressure. The comparison may be used to determine whether the predefined pressure condition is maintained within each of the first enclosure 106A and the second enclosure 106B for accurately performing the sealing process.

In another embodiment, the comparison module 202C is configured to compare the pressure within each of the first enclosure 106A and the second enclosure 106B with the predefined threshold value 204C for verifying that the pressure within each of first enclosure 106A and the second enclosure 106B is less than the predefined threshold value 204C to avoid any risks of causing physical damages to the first enclosure 106A and the second enclosure 106B.

The output module 202D may be configured to output the control data 204D. In an embodiment, the output module 202D of the processor 202 may be configured to output the control data via the user interface for controlling the operation of each of the first testing device 104A and the second testing device 104B. In an example, the output module 202D may output the updated control data 204D to the user for controlling each of the first testing device 104A and the second testing device 104B.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the apparatus 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein.

The memory 204 of the system 202 may be configured to store the test data 204A. In an embodiment, the test data 204A may include pressure characteristics data associated with each of the first enclosure 106A and the second enclosure 106B, flow characteristics data associated with each of the first enclosure 106A and the second enclosure 106B, and leakage characteristics data associated with each of the first enclosure 106A and the second enclosure 106B. The pressure characteristics data may include the pressure within the first enclosure 106A when the first testing device 104A is not operating and the pressure within the second enclosure 106B when the second testing device 104B is not operating. The flow characteristics data may include a flow rate of the fluid within each of the first enclosure 106A and the second enclosure 106B. The leakage characteristics data may include enclosure characteristics data and information about the one or more leaks present in the first enclosure 106A and the second enclosure 106B. The enclosure characteristics data may include the information about materials, shapes, size and geometry of the first enclosure 106A and the second enclosure 106B, respectively. The test data 204A may be received from the one or more data sources. In an example, the test data 204A may be received from the user input. In an alternate example, the test data 204A may be received from the one or more sensors 108.

The pressure data 204B may correspond to the pressure within the first enclosure 106A and the second enclosure 106B when the first testing device 104A and the second testing device 104B may be operating, respectively. In an embodiment, the pressure data 204B includes the first pressure value associated with the first enclosure 106A with the first testing device 104A operating therein. The pressure data 204B further includes the second pressure value associated with the second enclosure 106B with the second testing device 104B operating therein. The pressure data 204B may be received from the one or more sensors 108. In an example, the pressure data 204B may be received from the manometer.

In various embodiments, the predefined threshold value 204C may be associated with the predefined pressure conditions for effectively performing the sealing process. The predefined threshold value 204C may correspond to the predefined target pressure, which may be needed to maintain within each of the first enclosure 106A and the second enclosure 106B, respectively for effectively performing the sealing process. The predefined threshold value 204C may further refer to the maximum safe pressure value up to which may be maintained within the first enclosure 106A and the second enclosure 106B without causing any physical damage. In an embodiment, the predefined threshold value 204C may be received from the user input for performing the sealing process. In an exemplary embodiment, the system 102 may determine the predefined threshold value 204C based on the enclosure characteristics received via the user input. For example, the predefined threshold value 204C may be, but not limited to, 200 Pa.

The control data 204D may further include instructions for controlling the operation of each of the first testing device 104A and the second testing device 104B. The control data 204D may include the first control signal and the second control signal. The control data 204D may be used for controlling the operation of the first testing device 104A based on the first control signal and controlling the operation of the second testing device 104B based on the second control signal. The control data 204D may further be displayed to the user for controlling each of the first testing device 104A and the second testing device 104B.

In some example embodiments, the I/O interface 206 may communicate with the system 102 and display the input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 may include a user interface circuitry configured to control at least some functions of one or more I/O interface elements such as a display and, in some embodiments, a plurality of speakers, a ringer, one or more microphones and/or the like. The processor 202 and/or the I/O interface 206 circuitry may be configured to control one or more functions of the system 102 through computer program instructions (for example, software and/or firmware) stored on the memory 204 accessible to the processor 202.

The communication interface 208 may comprise an input interface and an output interface for supporting communications to and from the system 102 or any other component with which the system 102 may communicate. The communication interface 208 may be any means, such as a device or circuitry embodied in either hardware or a combination of hardware and software that is configured to receive and/or transmit data to/from a communications device in communication with the system 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms. In some embodiments, the communication interface 208 may enable communication with a cloud-based network to enable deep learning, such as using a machine learning model (that may be hosted on the cloud-based network).

FIG. 3 illustrates an exemplary block diagram of a test environment 300 including a sealant delivery unit and a fluid delivery unit, in accordance with an example embodiment of the present disclosure. With reference to FIG. 3, there is shown the test environment 300. The test environment 300 includes a sealant delivery unit 302 and a fluid delivery unit 312. The test environment 300 further includes the first testing device 112A, the first control unit 114A a lay flat 318, and an enclosure 320. The sealant delivery unit 302 may further include a sealant testing device 304, a sealant control unit 306, a sealant storage unit 308 and a dispersion device 310. The fluid delivery unit 312 includes a fluid testing device 314 and a fluid control unit 316. FIG. 3 is explained in conjunction with FIG. 1A, FIG. 1B and FIG. 2.

The sealant delivery unit 302 may be configured to disperse a stream of an aerosolized sealant into the enclosure 320 via the lay flat 318 for performing the sealing process. The sealant delivery unit 302 may obtain the aerosolized sealant from the sealant storage unit 308 and then cause the dispersion device 310 to disperse the stream of the aerosolized sealant into the fluid supplied by the fluid delivery unit 312. The sealant delivery unit 302 may further include the sealant testing device 304.

The sealant testing device 304 may be configured to supply the sealant for performing the sealing process within the enclosure 320 . . . enclosure 320. The sealant testing device 304 may supply the aerosolized sealant to the fluid supplied by the fluid delivery system 312 into the enclosure 320 for sealing one or more leaks present within the enclosure 320. The aerosolized sealant may then stick to the edges of the one or more leaks, and effectively seal them.

Similarly, in an embodiment, the first testing device 104A is associated with a first sealant delivery unit and the second testing device 104B is associated with a second sealant delivery unit. Each of the first sealant delivery unit and the second sealant delivery unit disperses the stream of the aerosolized sealant into the respective first enclosure 106A and the second enclosure 106B. Each of the first sealant delivery unit and the second delivery unit corresponds to the sealant delivery unit 302 and include the one or more components associated with the sealant delivery unit 302.

The sealant delivery unit 302 may further include the sealant control unit 306. The control unit 306 may include suitable logic, circuitry, and/or code that may be configured to control the operations of the sealant testing device 304.

The sealant storage unit 308 may refer to a sealant storage tank. The sealant storage unit 308 may serve as a reservoir for storing the aerosolized sealant. The sealant storage unit 308 may be used to store the aerosolized sealant, which may be used during the sealing process to seal the one or more leaks. The dispersion device 310 is a device for injecting a stream of the aerosolized sealant into the fluid supplied by the fluid delivery unit 312. Examples of the dispersion device may include one of, for example, but not limited to, an injector, a nozzle, a sprayer or an atomizer.

The fluid delivery unit 312 may be configured to disperse a stream of the fluid into the enclosure 320 via the lay flat 318 for performing the sealing process. The fluid delivery unit 312 may correspond to a fan, pump or a compressor, which may be configured to deliver the fluid into the enclosure 320. The fluid testing device 314 may be configured to supply the fluid for performing the sealing process. The fluid control unit 316 may include suitable logic, circuitry, and/or code that may be configured to control the operations of the fluid testing device 314. Similarly, in an embodiment, the first testing device 104A is associated with a first fluid delivery unit and the second testing device 104B is associated with a second fluid delivery unit.

The lay flat 318 allows a passage and a direction of the generated fluid from the testing device 112A to the enclosure 320. Structurally, the lay flat 304 may extend from an air movement device, on the testing device side, to the enclosure 320 at its inlet. At the inlet, the lay flat 318 delivers the fluid. Towards the side of the testing device 112A, the lay flat 318 may be shaped to complement and fasten over fixtures. Towards the enclosure side, the lay flat 318 may similarly extend to connect and communicate with the enclosure's inlet.

The enclosure 320 corresponds to the first enclosure 106A and may be connected to the sealant delivery unit 302 via the lay flat 318 for performing the sealing process. Similarly, the first enclosure 106A may be connected to the first sealing delivery unit via a first lay flat and the second enclosure 106B may be connected to the second sealing delivery unit via a second lay flat for performing the sealing process within each of the first enclosure 106A and the second enclosure 106B.

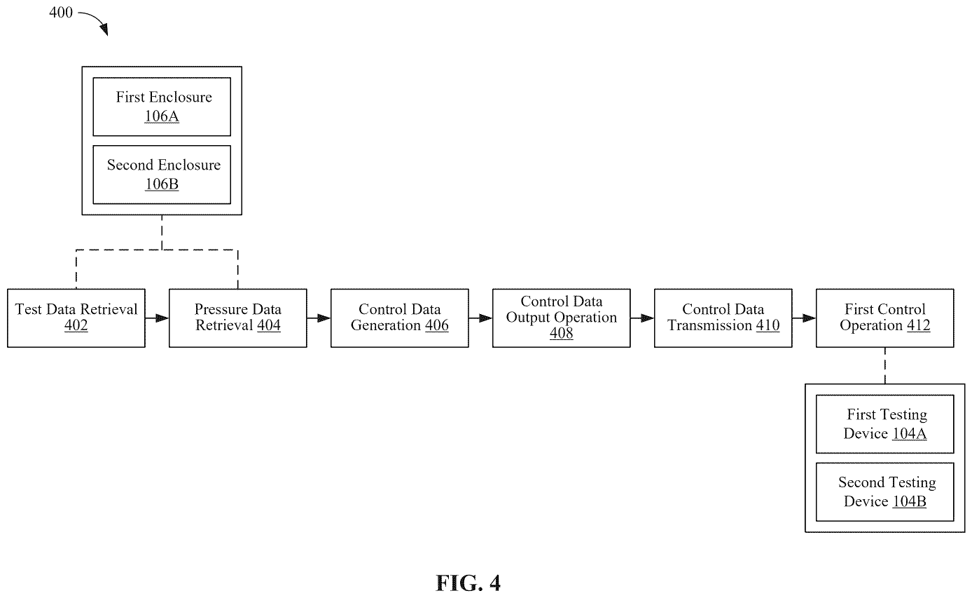

FIG. 4 is a diagram that illustrates a first set of exemplary operations for controlling operations of a plurality of testing devices, in accordance with an example embodiment of the present disclosure. With reference to FIG. 4, there is shown the block diagram 400 that illustrates exemplary operations from 402 to 412, as described herein. The exemplary operations illustrated in the block diagram 400 may start at 402 and may be performed by the system 102 of FIG. 1 or the processor 202 of FIG. 2. Although illustrated with discrete blocks, the exemplary operations associated with one or more blocks of the block diagram 400 may be divided into additional blocks, combined into fewer blocks, or eliminated, depending on the particular implementation. FIG. 4 is explained in conjunction with FIG. 1A, FIG. 1B, FIG. 2 and FIG. 3.

At 402, a test data retrieval operation is performed. In an embodiment, the system 102 receives the test data 204A from the one or more data sources. The test data 204A may include at least one of the pressure characteristics data associated with each of the first enclosure 106A and the second enclosure 106B, the flow characteristics data associated with each of the first enclosure 106A and the second enclosure 106B, and the leakage characteristics data associated with each of the first enclosure 106A and the second enclosure 106B.

In an exemplary embodiment, the system 102 receives the leakage characteristics data from the user input. The user may provide the enclosure characteristics data. For example, the user may provide the information about the material, the shape and the size of the first enclosure 106A and the second enclosure 106B.

At 404, a pressure data retrieval operation is performed. In an embodiment, the system 102 receives the pressure data 204B from the one or more sensors 108. The pressure data 204B includes the first pressure value associated with the first enclosure 106A with the first testing device 104A operating therein. The pressure data 204B further includes the second pressure value associated with the second enclosure 106B with the second testing device 104B operating therein. In an example, the system 102 receives the pressure 204B from the manometer associated with each of the first enclosure 106A and the second enclosure 106B.

At 406, a control data generation operation is performed. In an embodiment, the system 102 generates the control data 204D for controlling the operation of each of the first testing device 104A and the second testing device 104B. The control data 204D may be generated based on the test data 204A and the pressure data 204B. The control data 204D includes the first control signal and the second control signal. In an exemplary embodiment, the system 102 determines that each of the first pressure value and the second pressure value is less than the predefined target pressure which needs to be maintained to achieve the predefined pressure conditions. The system 102 may then generate the control data to control the operation of speeding up each of the first testing device 104A or the second testing device 104B.

In an additional embodiment, the system 102 is configured to generate the first control signal for controlling the operation of the first testing device 104 based on the test data 204A and the pressure data 204B associated with the first enclosure 106A. In an exemplary embodiment, the system 102 generates the first control signal to increase a speed of the fan corresponding to the first testing device 104A to increase the pressure within the first enclosure to maintain the predefined pressure conditions.

In another additional embodiment, the system 102 is configured to generate the second control signal for controlling the operation of the second testing device 104 based on the test data 204A and the pressure data 204B associated with the second enclosure 106B. In an exemplary embodiment, the system 102 generates the second control signal to speed up the fan corresponding to the second testing device 104B to increase the pressure within the second enclosure 106B to maintain the predefined pressure conditions.

At 408, a control data output operation is performed. In an embodiment, the system 102 outputs the control data 204D via the user interface for controlling the operation of each of the first testing device 104A and the second testing device 104B. In an example, the system 102 may output the control data 204D to the user in form of one or more instructions to control the first testing device 104A and the second testing device 104B.

At 410, a control data transmission operation is performed. In an embodiment, the system 102 is configured to transmit the first control signal to the first control unit 114A associated with the first testing device 104A. In an example, the system 102 may transmit the first control signal to the first control unit 114A via the communication network 110. The system 102 may transmit the first control signal to the first control unit 114A for speeding up the fan corresponding to the first testing device 104A. The first control unit 114A may be connected with the system 102 via the communication network 110.

In another embodiment, the system 102 is configured to transmit the second control signal to the second control unit 114B associated with the second testing device 104B. In an example, the system 102 may transmit the second control signal to the second control unit 114B via the communication network 110. The system 102 may transmit the second control signal to the second control unit 114B for speeding up the fan corresponding to the second testing device 104B. The second control unit 114B may be connected with the system 102 via the communication network 110.

At 412, a first control operation is performed. In an embodiment, the system 102 causes to control the operation of the first testing device 104A and the second testing device 104B simultaneously based on the first control signal and the second control signal. In an exemplary embodiment, the system 102 may cause to speed up the fan corresponding to each of the first testing device 104A and the second testing device 104B simultaneously based on the first control signal and the second control signal, respectively.

In another embodiment, the system 102 causes each of the first control unit 114A and the second control unit 114B to control the first testing device 104A and the second testing device 104B, respectively, to achieve the predefined pressure condition within each of the first enclosure 106A and the second enclosure 106B. In an exemplary embodiment, the system 102 may cause the first control unit 114A and the second control unit 114B to speed up the fan corresponding to each of the first testing device 104A and the second testing device 104, to achieve the predefined pressure condition within each of the first enclosure 106A and the second enclosure 106B.

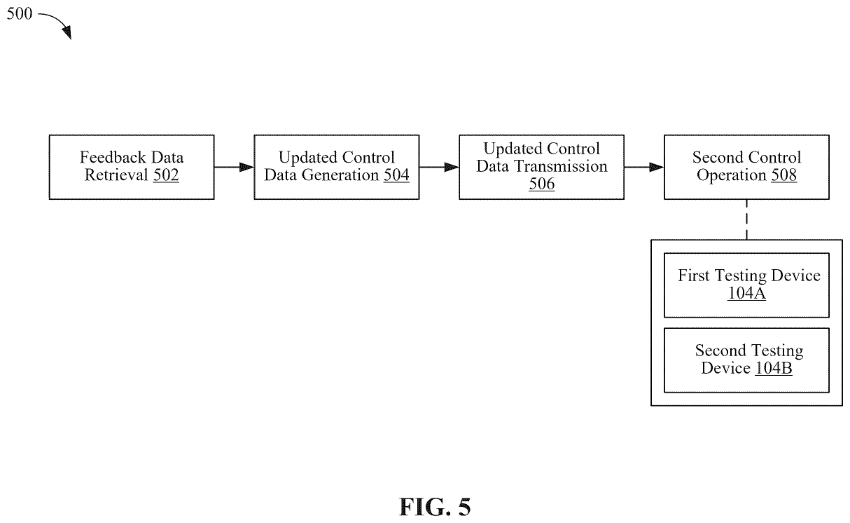

FIG. 5 is a diagram that illustrates a second set of exemplary operations for controlling operations of a plurality of testing devices, in accordance with an example embodiment of the present disclosure. With reference to FIG. 5, there is shown the block diagram 500 that illustrates exemplary operations from 502 to 508, as described herein. The exemplary operations illustrated in the block diagram 500 may start at 502 and may be performed by the system 102 of FIG. 1 or the processor 202 of FIG. 2. Although illustrated with discrete blocks, the exemplary operations associated with one or more blocks of the block diagram 500 may be divided into additional blocks, combined into fewer blocks, or eliminated, depending on the particular implementation. FIG. 5 is explained in conjunction with FIG. 1 A, FIG. 1B, FIG. 2, FIG. 3 and FIG. 4.

At 502, a feedback data retrieval operation is performed. In an embodiment, the system 102 is configured to receive feedback data associated with the first enclosure 106A, the second enclosure 106B, the first testing device 104A and/or the second testing device 104B. The system 102 may receive the feedback data based on the operation of each of the first testing device 104A within the first enclosure 106A, and the second testing device 104B within the second enclosure 106B. The feedback data refers to the data received by the system 102 in response to performing the first control operation 412. In an example, the system 102 may receive the feedback data from the first control unit 114A and the second control unit 114B based on performing the first control operation 412.

In an additional embodiment, the feedback data includes, for example, updated first pressure value associated with the first enclosure 106A, updated second pressure value associated with the second enclosure 106B, first operation parameters associated with the operation of the first testing device 104A, or second operation parameters associated with the operation of the second testing device 104B. The updated first pressure value corresponds to the pressure achieved within the first enclosure 106A based on speeding up the fan corresponding to the first testing device 104A. The updated second pressure value corresponds to the pressure achieved within the second enclosure 106B based on speeding up the fan corresponding to the second testing device 104B. The first operation parameters correspond to at least one operational parameter associated with the speeding up of the first testing device 104A. The second operation parameters correspond to at least one operation parameter associated with speeding up the second testing device 104B. Examples of at least one operation parameter may be one of, but not limited to, a speed parameter, a flow parameter, or a pressure parameter.

In an exemplary embodiment, the system 102 may receive the feedback data from the first control module and the second control module based on performing the first control operation 412. For example, when the speed of the fan corresponding to each of the first testing device 104A and the second testing device 104B is increased, the pressure within the first enclosure 106A and the second enclosure 106B is increased to achieve the predefined pressure condition. In this context, the system 102 receives the feedback data including the updated first pressure value and the updated second pressure value.

At 504, an updated control data generation operation is performed. In an embodiment, the system 102 is configured to generate updated control data based on the feedback data and the predefined pressure condition. The system 102 generates the updated control data for controlling the operation of the first testing device 104A and/or the second testing device 104B. The updated control data includes an updated first control signal for the first testing device 104A and/or an updated second control signal for the second testing device 104B. The updated first control signal is used to control the first testing device 104A and the updated second control signal is used to control the second testing device 104B.

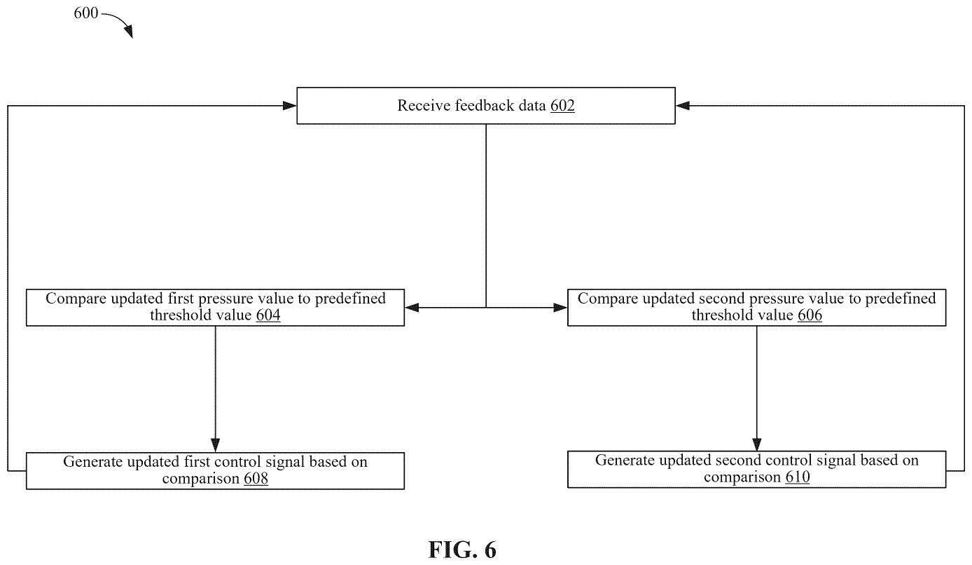

In an exemplary embodiment, the system 102 generates the updated control data based on comparing the feedback data with the predefined threshold value 204C associated with the predefined pressure conditions. For example, when the updated first pressure value is greater than the predefined threshold value 204C, the system 102 generates the updated first control signal to slow down the fan corresponding to the first testing device 104A to reduce the pressure within the first enclosure 106A to avoid any physical damages to the first enclosure 106A. Similarly, the system generates the updated second control signal to slow down the second testing device 104B to avoid any physical damage to the second enclosure 106B. Details about the control data generation are further provided in FIG. 6.

At 506, an updated control data transmission operation is performed. In an embodiment, the system is configured to transmit the updated control data to the first control unit 114A and/or the second control unit 114B. The system 102 may transmit the updated control data via the communication network 110. In an exemplary embodiment, the system 102 transmits the updated control data including the updated first control signal to the first control unit 114A based on when the updated first pressure value may be greater than the predefined threshold value 204C.

In an alternate exemplary embodiment, the system 102 transmits the updated control data including the updated second control signal to the second control unit 114B based on when the updated second pressure value may be greater than the predefined threshold value 204C. The system 102 transmits the updated second control signal to slow down the second testing device 104B to reduce the pressure within the second enclosure 106B to avoid any physical damage to the second enclosure 106B.

At 508, a second control operation is performed. In an embodiment, the system 102 is configured to cause the first control unit 114A to control the first testing device 104A and/or the second control unit 114B to control the second testing device 104B based on the updated control data. In an exemplary embodiment, the system may cause either the first control unit 114A and the second control unit 114B to control the first testing device 104A or the second testing device 104B, respectively based on the updated control data.

In another embodiment, the system is configured to cause the first control unit 114A to control the first testing device 104A based on the updated first control signal. In an exemplary embodiment, the system 102 causes the first control unit 114A to slow down the fan corresponding to the first testing device 104A based on the updated first control signal. The system 102 may slow down the fan corresponding to the first testing device 104A to avoid any physical damage to the first enclosure 106A.

In an additional embodiment, the system is configured to simultaneously cause the second control unit 114B to control the second testing device based on the updated second control signal; or vice-versa. In an exemplary embodiment, the system 102 simultaneously causes the second control unit 114B to slow down the fan corresponding to the second testing device 104B based on the updated second control signal. For example, when each of the updated first pressure value and the second pressure value is greater than the predefined threshold value 204C, the system 102 causes to slow down each of the first testing device 104A and the second testing device 104B simultaneously to avoid any physical damages to the first enclosure 106A and the second enclosure 106B.

FIG. 6 is a diagram that illustrates a first exemplary method for generating updated control data, in accordance with an example embodiment of the present disclosure. FIG. 6 is explained in conjunction with elements from FIG. 1A, FIG. 1B, FIG. 2, FIG. 3, FIG. 4 and FIG. 5. With reference to FIG. 6, there is shown the flowchart 600. The operations of the exemplary method may be executed by the system 102 of FIG. 1 or the processor 202 of FIG. 2. The operations of the flowchart 600 may start at 602.

At 602, the feedback data is received. In an embodiment, the system 102 may receive the feedback data associated with at least one of the first enclosure 106A, the second enclosure 106B, the first testing device 104A or the second testing device 104B. The feedback data includes the updated first pressure value associated with the first enclosure 106A, the updated second pressure value associated with the second enclosure 106B, the first operation parameters associated with the operation of the first testing device 104A, or the second operation parameters associated with the operation of the second testing device 104B.

At 604, the updated first pressure value is compared with the predefined threshold value 204C. In an embodiment, the system 102 is configured to compare the updated first pressure value associated with the first enclosure 106A with the predefined threshold value 204C associated with the predefined pressure condition. Then, the system 102 may determine whether the updated first pressure value is greater than or less than the predefined threshold value 204C based on the comparison. In an example, the comparison module 202C may compare the updated first pressure value with the predefined threshold value.

At 606, the updated second pressure value is compared with the predefined threshold value 204C. In an embodiment, the system 102 is configured to compare the updated second pressure value associated with the second enclosure 106B with the predefined threshold value 204C associated with the predefined pressure condition. Then, the system 102 may determine whether the updated second pressure value is greater or less than the predefined threshold value 204C based on the comparison. In an example, the comparison module 202C may compare the updated second pressure value with the predefined threshold value.

Based on the determination that the updated first pressure value is greater or less than the predefined threshold value 204C, the control of operations of the flowchart 600 further proceeds to 608. Similarly, based on the determination that the updated second pressure value is greater than or lesser than the predefined threshold value 204C, the control of operations of the flowchart 600 further proceeds to 610.

At 608, the updated first control signal is generated. In an embodiment, the system 102 is configured to generate the updated first control signal based on the comparison and the first operation parameters associated with the operation of the first testing device. The system 102 is configured to generate the updated first control signal to slow down the first testing device 104A based on the determination that the updated first pressure is greater than the predefined threshold value 204C. The system 102 is further configured to generate the updated first control signal to speed up the first testing device 104A based on when the updated first pressure value is lesser than the predefined threshold value 204C.

In an exemplary embodiment, when the updated first pressure value tend is lesser than the predefined threshold value 204C associated with the predefined pressure conditions for effectively performing the sealing process, then the system 102 may generate the updated first control signal to speed up the first testing device 104A. In an alternate exemplary embodiment, when the fan corresponding to the first testing device 104A is controlled to increase the pressure within the first enclosure 106A for achieving the predefined pressure conditions for performing the sealing process, the updated first pressure may tend to become greater than the predefined threshold value 204C, which may cause physical damages to the first enclosure 106A. Then the system 102 may generate the updated first control signal to slow down the fan corresponding to the first testing device 104A.

At 610, the updated second control signal is generated. In an embodiment, the system 102 is configured to generate the updated second control signal based on the comparison and the second operation parameters associated with the operation of the second testing device. The system 102 is configured to simultaneously generate the updated second control signal to slow down the second testing device 104B based on the determination that the updated second pressure is greater than the predefined threshold value 204C. The system 102 is further configured to generate the updated second control signal to speed up the second testing device 104B based on when the updated second pressure value is lesser than the predefined threshold value 204C.

In an exemplary embodiment, when the updated second pressure value tend is lesser than the predefined threshold value 204C associated with the predefined pressure conditions for effectively performing the sealing process, then the system 102 may generate the updated second control signal to speed up the second testing device 104B. In an alternate exemplary embodiment, when the fan corresponding to the second testing device 104B is controlled to increase the pressure within the second enclosure 106B for achieving the predefined pressure conditions for performing the sealing process, the updated second pressure may tend to become greater than the predefined threshold value 204C, which may cause physical damages to the second enclosure 106B. Then the system 102 may generate the updated second control signal to slow down the fan corresponding to the second testing device 104B.

Accordingly, blocks of the flowchart 600 support combinations of means for performing the specified functions and combinations of operations for performing the specified functions. It will also be understood that one or more blocks of the flowchart 600 can be implemented by special-purpose hardware-based computer systems which perform the specified functions, or combinations of special-purpose hardware and computer instructions.

Alternatively, the system 102 may include means for performing each of the operations described above. In this regard, according to an example embodiment, examples of means for performing operations may include, for example, the processor 202 and/or a device or circuit for executing the computer program instructions or executing an algorithm for processing information as described above.

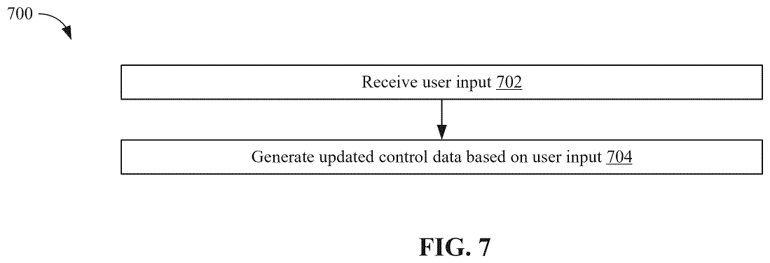

FIG. 7 is a diagram that illustrates a second exemplary method for generating updated control data, in accordance with an example embodiment of the present disclosure. FIG. 7 is explained in conjunction with elements from FIG. 1A, FIG. 1B, FIG. 2, FIG. 3, FIG. 4, FIG. 5 and FIG. 6. With reference to FIG. 7, there is shown the flowchart 700. The operations of the exemplary method may be executed by the system 102 of FIG. 1 or the processor 202 of FIG. 2. The operations of the flowchart 700 may start at 702.

At 702, a user input is received. In an embodiment, the system 102 is configured to receive the user input via the user interface. The user input is associated with the operation of at least one of the first testing device 104A or the second testing device 104B. The user input may include the predefined threshold value 204C. The system 102 may receive the predefined threshold value 204C as the user input for generating the updated first control signal and the second control signal. In an example, the input module 202C receives the user input.

In an exemplary embodiment, the system 102 may receive the user input, which includes the information associated with the operation of slowing down or speeding up the first testing device 104A. In another exemplary embodiment, the system 102 may receive the user input, which includes the information associated with the operation of slowing down or speeding up the second testing device 104B.

At 704, the updated control data is generated based on the user input. In an embodiment, the system is configured to generate the updated control data for controlling the operation of the first testing device 104A and the second testing device 104B based on the user input. In an exemplary embodiment, the system 102 may generate the updated control data for slowing down the fan corresponding to each of the first testing device 104A and the second testing device 104B based on when each of the updated first pressure value and the updated second pressure value is greater than the predefined threshold value 204C, received from the user input.

In another exemplary embodiment, the system 102 generates the updated control data for slowing down or speeding down the first testing device 104A, based on when the user input includes the information associated with the operation of slowing down or speeding up the first testing device 104A. In an alternate exemplary embodiment, the system 102 generates the updated control data for slowing down or speeding down the second testing device 104B, based on when the user input includes the information associated with the operation of slowing down or speeding up the second testing device 104B.

Accordingly, blocks of the flowchart 700 support combinations of means for performing the specified functions and combinations of operations for performing the specified functions. It will also be understood that one or more blocks of the flowchart 700 can be implemented by special-purpose hardware-based computer systems which perform the specified functions, or combinations of special-purpose hardware and computer instructions.

Alternatively, the system 102 may include means for performing each of the operations described above. In this regard, according to an example embodiment, examples of means for performing operations may include, for example, the processor 202 and/or a device or circuit for executing the computer program instructions or executing an algorithm for processing information as described above.

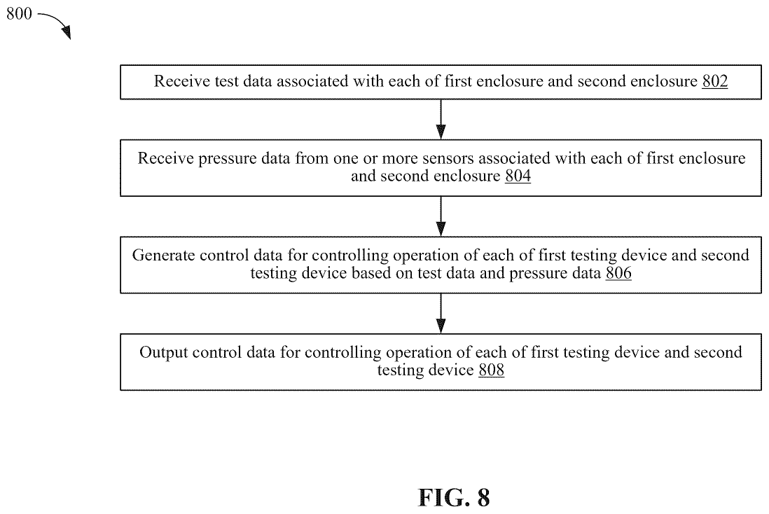

FIG. 8 is a diagram that illustrates an exemplary method for controlling a plurality of testing devices, in accordance with an example embodiment of the present disclosure. FIG. 8 is explained in conjunction with elements from FIG. 1A, FIG. 1B, FIG. 2, FIG. 3, FIG. 4, FIG. 5, FIG. 6 and FIG. 7. With reference to FIG. 8, there is shown the flowchart 800. The operations of the exemplary method may be executed by the system 102 of FIG. 1 or the processor 202 of FIG. 2. The operations of the flowchart 800 may start at 802.

At 802, the test data 204A associated with each of the first enclosure 106A and the second enclosure 106B is received. In an embodiment, the system 102 is configured to receive the test data 204A associated with each of the first enclosure 106A and the second enclosure 106B from the one or more data sources. The first enclosure 106A is associated with the first testing device 104A of the plurality of testing devices 104 and the second enclosure 106B is associated with the second testing device 104B of the plurality of testing devices 104. In an example, the input module 202A of the processor 202 receives the test data 204A. Details about the test data retrieval operation are described in FIG. 1, FIG. 2 and FIG. 3.

At 804, the pressure data 204B is associated with each of the first enclosure 106A and the second enclosure 106B is received from the one or more sensors 108. In an embodiment, the system 102 is configured to receive the pressure data 204B associated with each of the first enclosure 106A and the second enclosure 106B from the one or more sensors 108. The pressure data 204B includes the first pressure value associated with the first enclosure 106A with the first testing device 104A operating therein. The pressure data further includes the second pressure value associated with the second enclosure 106B with the second testing device 104B operating therein. In an example, the input module 202A of the processor 202 receives the pressure data 204B. Details about the pressure data retrieval operation are provided in FIG. 1, FIG. 2 and FIG. 3.

At 806, the control data 204D for controlling the operation of each of the first testing device 104A and the second testing device 104B is generated based on the test data 204A and the pressure data 204B. In an embodiment, the system is configured to generate the control data 204D for controlling the operation of each of the first testing device 104A and the second testing device 104B based on the test data 204A and the pressure data 204B. The control data 204D includes the first control signal for controlling the operation of the first testing device 104A and the second control signal for controlling the operation of the second testing device 104B. The operation of each of the first testing device 104A and the second testing device 104B is controlled to achieve the predefined pressure conditions within each of the first enclosure 106A and the second enclosure 106B. In an example, the control data generation module 202B of the processor 202 generates the control data 204D. Details about the control data generation operation is provided in FIG. 1, FIG. 2 and FIG. 3.

At 808, the control data 204D is output for controlling the operation of each of the first testing device 104A and the second testing device 104B. In an embodiment, the system 102 is configured to output the control data 204D via the user interface for controlling the operation of each of the first testing device 104A and the second testing device 104B. In an example, the output module 202D of the processor 202 outputs the control data 204D. Details about the control data output operation are provided in FIG. 1, FIG. 2 and FIG. 3.

Accordingly, blocks of the flowchart 800 support combinations of means for performing the specified functions and combinations of operations for performing the specified functions. It will also be understood that one or more blocks of the flowchart 800 can be implemented by special-purpose hardware-based computer systems which perform the specified functions, or combinations of special-purpose hardware and computer instructions.

Alternatively, the system 102 may include means for performing each of the operations described above. In this regard, according to an example embodiment, examples of means for performing operations may include, for example, the processor 202 and/or a device or circuit for executing the computer program instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system for controlling operations of a plurality of testing devices, the system comprising:
a memory configured to store computer executable instructions; and
one or more processors configured to execute the instructions to:
receive, from one or more data sources, test data associated with each of a first enclosure and a second enclosure, wherein the first enclosure is associated with a first testing device of the plurality of testing devices, and wherein the second enclosure is associated with a second testing device of the plurality of testing devices;
receive, from one or more sensors associated with each of the first enclosure and the second enclosure, pressure data, wherein the pressure data comprises a first pressure value associated with the first enclosure with the first testing device operating therein, and wherein the pressure data comprises a second pressure value associated with the second enclosure with the second testing device operating therein;
generate control data for controlling an operation of each of the first testing device and the second testing device based on the test data and the pressure data, the control data comprising a first control signal for controlling the operation of the first testing device and a second control signal for controlling the operation of the second testing device, wherein the operation of each of the first testing device and the second testing device is controlled to achieve a predefined pressure condition within each of the first enclosure and the second enclosure; and
output, via a user interface, the control data for controlling the operation of each of the first testing device and the second testing device.

2. The system of claim 1, wherein the predefined pressure condition is associated with performing one of: a sealing operation within each of the first enclosure and the second enclosure, or a testing operation within each of the first enclosure and the second enclosure.

3. The system of claim 1, wherein the one or more processors configured to:
generate the first control signal for controlling the operation of the first testing device based on the test data and the pressure data associated with the first enclosure;
generate the second control signal for controlling the operation of the second testing device based on the test data and the pressure data associated with the second enclosure; and
cause to control the operation of the first testing device and the second testing device simultaneously based on the first control signal and the second control signal.

4. The system of claim 1, wherein the one or more processors configured to:
transmit the first control signal to a first control unit associated with the first testing device;
transmit the second control signal to a second control unit associated with the second testing device; and
cause, each of the first control unit and the second control unit, to control the first testing device and the second testing device to achieve the predefined pressure condition within each of the first enclosure and the second enclosure.

5. The system of claim 4, wherein the one or more processors configured to:
receive feedback data associated with at least one of: the first enclosure, the second enclosure, the first testing device or the second testing device, based on an operation of each of the first testing device within the first enclosure, and the second testing device within the second enclosure;
generate updated control data for controlling an operation of at least one of: the first testing device, or the second testing device based on the feedback data and the predefined pressure condition, wherein the updated control data comprises at least one of: an updated first control signal for the first testing device, or an updated second control signal for the second testing device;
transmit the updated control data to at least one of: the first control unit, or the second control unit; and
cause, at least one of: the first control unit, or the second control unit, to control corresponding the first testing device or the second testing device based on the updated control data.

6. The system of claim 5, wherein the one or more processors configured to:
cause, the first control unit, to control the first testing device based on the updated first control signal; and
simultaneously cause, the second control unit, to control the second testing device based on the updated second control signal; or vice-versa.

7. The system of claim 5, wherein the feedback data comprises at least one of: updated first pressure value associated with the first enclosure, updated second pressure value associated with the second enclosure, first operation parameters associated with the operation of the first testing device, or second operation parameters associated with the operation of the second testing device.

8. The system of claim 7, wherein the one or more processors are further configured to:
compare the updated first pressure value associated with the first enclosure with a predefined threshold value associated with the predefined pressure condition; and
generate the updated first control signal based on the comparison and the first operation parameters associated with the operation of the first testing device.

9. The system of claim 7, wherein the one or more processors are further configured to:
compare the updated second pressure value associated with the second enclosure with a predefined threshold value associated with the predefined pressure condition; and
generate the updated second control signal based on the comparison and the second operation parameters associated with the operation of the second testing device.

10. The system of claim 5, wherein the one or more processors are further configured to:
receive, via the user interface, a user input associated with the operation of at least one of: the first testing device, or the second testing device; and
generate the updated control data for controlling the operation of at least one of: the first testing device and the second testing device based on the user input.

11. The system of claim 1, wherein the test data comprises at least one of: pressure characteristics data associated with each of the first enclosure and the second enclosure, flow characteristics data associated with each of the first enclosure and the second enclosure, and leakage characteristics data associated with each of the first enclosure and the second enclosure.

12. The system of claim 1, wherein each of the one or more sensors is a manometer.

13. The system of claim 1, wherein each of the first testing device and the second testing device is one of: a fan, a compressor or a pump.

14. The system of claim 1, wherein each of the first testing device and the second device supplies a fluid to each of the first enclosure and the second enclosure, and wherein the fluid comprises at least a portion of an aerosolized sealant.

15. The system of claim 1, wherein the first testing device is associated with a first sealant delivery unit and the second testing device is associated with a second sealant delivery unit, and wherein each of the first sealant delivery unit and the second sealant delivery unit disperses a stream of the aerosolized sealant into the respective first enclosure and the second enclosure.

16. A method for controlling operations of a plurality of testing devices, the method comprising:
receiving, from one or more data sources, test data associated with each of a first enclosure and a second enclosure, wherein the first enclosure is associated with a first testing device of the plurality of testing devices, and wherein the second enclosure is associated with a second testing device of the plurality of testing devices;
receiving, from one or more sensors associated with each of the first enclosure and the second enclosure, pressure data, wherein the pressure data comprises a first pressure value associated with the first enclosure with the first testing device operating therein, and wherein the pressure data comprises a second pressure value associated with the second enclosure with the second testing device operating therein;
generating control data for controlling an operation of each of the first testing device and the second testing device based on the test data and the pressure data, the control data comprising a first control signal for controlling the operation of the first testing device and a second control signal for controlling the operation of the second testing device, wherein the operation of each of the first testing device and the second testing device is controlled to achieve a predefined pressure condition within each of the first enclosure and the second enclosure; and
outputting, via a user interface, the control data for controlling the operation of each of the first testing device and the second testing device.

17. The method of claim 16, further comprising:
generating the first control signal for controlling the operation of the first testing device based on the test data and the pressure data associated with the first enclosure;
transmitting the first control signal to a first control unit associated with the first testing device;
generating the second control signal for controlling the operation of the second testing device based on the test data and the pressure data associated with the second enclosure;
transmitting the second control signal to a second control unit associated with the second testing device; and
causing, each of the first control unit and the second control unit, to control the first testing device and the second testing device to achieve the predefined pressure condition within each of the first enclosure and the second enclosure.

18. The method of claim 17, further comprising:
receiving feedback data associated with at least one of: the first enclosure, the second enclosure, the first testing device or the second testing device, based on an operation of each of the first testing device within the first enclosure, and the second testing device within the second enclosure;
generating updated control data for controlling an operation of at least one of: the first testing device, or the second testing device based on the feedback data and the predefined pressure condition, wherein the updated control data comprises at least one of: an updated first control signal for the first testing device, or an updated second control signal for the second testing device;
transmitting the updated control data to at least one of: the first control unit, or the second control unit; and
causing, at least one of: the first control unit, or the second control unit, to control corresponding the first testing device or the second testing device based on the updated control data.

19. A computer programmable product for controlling operations of a plurality of testing devices, the computer programmable product comprising a non-transitory computer readable medium having stored thereon computer executable instructions, which when executed by one or more processors, cause the one or more processors to conduct operations, the operations comprising:
receiving, from one or more data sources, test data associated with each of a first enclosure and a second enclosure, wherein the first enclosure is associated with a first testing device of the plurality of testing devices, and wherein the second enclosure is associated with a second testing device of the plurality of testing devices;
receiving, from one or more sensors associated with each of the first enclosure and the second enclosure, pressure data, wherein the pressure data comprises a first pressure value associated with the first enclosure with the first testing device operating therein, and wherein the pressure data comprises a second pressure value associated with the second enclosure with the second testing device operating therein;
generating control data for controlling an operation of each of the first testing device and the second testing device based on the test data and the pressure data, the control data comprising a first control signal for controlling the operation of the first testing device and a second control signal for controlling the operation of the second testing device, wherein the operation of each of the first testing device and the second testing device is controlled to achieve a predefined pressure condition within each of the first enclosure and the second enclosure; and
outputting, via a user interface, the control data for controlling the operation of each of the first testing device and the second testing device.

20. The computer programmable product of claim 19, the operations further comprising:
receiving feedback data associated with at least one of: the first enclosure, the second enclosure, the first testing device or the second testing device, based on an operation of each of the first testing device within the first enclosure, and the second testing device within the second enclosure; and
generating updated control data for controlling an operation of at least one of: the first testing device, or the second testing device based on the feedback data and the predefined pressure condition, wherein the updated control data comprises at least one of: an updated first control signal for the first testing device, or an updated second control signal for the second testing device.
